(19) United States
(12) Patent Application Publication
(10) Pub. No.: US 2026/0219415 A1
(43) Pub. Date: Jul. 30, 2026

(54) LOOK-AHEAD INVERSION & UNCERTAINTY VISUALIZATION

(71) Applicant: Halliburton Energy Services, Inc., Houston, TX (US)

(72) Inventors: Hsu Hsiang Wu, Houston, TX (US); Dagang Wu, Houston, TX (US); Ivan Efimov, Houston, TX (US)

(73) Assignee: Halliburton Energy Services, Inc., Houston, TX (US)

(21) Appl. No.: 19/039,701

(22) Filed: Jan. 28, 2025

(51) Int. Cl. G01V 3/30; E21B 7/04; E21B 47/002

(52) U.S. Cl. CPC G01V 3/30; E21B 7/04; E21B 47/0025

(57) ABSTRACT

A non-transitory machine-readable medium having data stored therein representing a software executable by a computer. The software executable comprising instructions configured to receive one or more electromagnetic measurements surrounding an observation point from a well measurement system, invert the one or more electromagnetic measurements to form one or more formation electrical properties, and visualize the one or more formation electrical properties on an information handling system. The instructions are further configured to identify an azimuthal direction of a drill bit to follow in a formation based at least in part on the one or more formation electrical properties and instruct the drill bit to steer in the azimuthal direction.

### BACKGROUND

Modern petroleum drilling and production operations may demand a great quantity of information relating to the parameters and conditions downhole. Such information typically includes the location and orientation of the borehole and drilling assembly, earth formation properties, and parameters of the downhole drilling environment. The collection of information relating to formation properties and downhole conditions is commonly referred to as logging and can be performed during the drilling process itself (hence the term “logging while drilling” or “LWD,” frequently used interchangeably with the term “measurement while drilling” or “MWD”).

When plotted as a function of depth or tool position in the borehole, the logging tool measurements are termed “logs.” Resistivity logging, such as ultra-deep azimuthal resistivity (UDAR) logging, may be used in well logging to determine geological correlation of formation strata and detect and quantify potentially productive formation zones. Such logs may provide indications of hydrocarbon concentrations and other information useful to drillers and completion engineers. In particular, azimuthally-sensitive logs may provide information useful for steering the drilling assembly because they can inform the driller when a target formation bed has been entered or exited, thereby enabling modifications to the drilling program that will provide much more value and higher success than would be the case using only seismic data.

### BRIEF DESCRIPTION OF THE DRAWINGS

These drawings illustrate certain aspects of some examples of the present disclosure and should not be used to limit or define the disclosure.

FIG. 1 shows an illustrative logging while drilling (LWD) environment.

FIG. 2 shows an illustrative drill string with two logging tool modules.

FIG. 3 shows an illustrative logging tool and a surface system.

FIG. 4 shows an illustrative logging tool.

FIG. 5 illustrates a schematic of an information handling system.

FIG. 6 illustrates a schematic of a chip set.

FIG. 7 illustrates a computing network.

FIG. 8 illustrates a neural network.

FIGS. 9A & 9B are graphs that illustrate current visualization techniques for 3D resistivity data;

FIG. 10 is a graph that illustrates another 3D visualization of resistivity data from measurements taken by the well measurement system;

FIG. 11 illustrates a well measurement system taking one or more measurements from observation point of formation in a window of a drilling direction;

FIG. 12 illustrates a synthetic example of how 2D drilling information may be displayed;

FIG. 13 illustrates another example of a synthetic example of how 2D drilling information may be displayed;

FIG. 14 is a graph that visualizes inversion uncertainty;

FIGS. 15 & 16 are graphs that illustrate inversion distributions across different azimuthal directions from an observation point of well measurement system;

FIG. 17 illustrates a 2D curved plane to depict the estimated uncertainty at a fixed distance away from an observation point on well measurement system;

FIG. 18 is a graph showing the uncertainties form FIG. 20;

FIG. 19 is a graph of a one-dimensional (1D) resistivity log;

FIG. 20 illustrates a 3D visualization of the detected resistivity boundaries based on resistivity variations, using the 1D graph from FIG. 22;

FIGS. 21A and 21B are illustrations showing a transformation of results from FIG. 23 into more practical geosteering information;

FIGS. 22A and 22B illustrate further indicate a distance to the boundary but also distinguishes the resistivity values by using positive or negative signs to define whether the boundary has higher or lower resistivity, respectively; and

FIG. 23 illustrates a different color palette that may be used to convey the same information illustrated in FIG. 20.

### DETAILED DESCRIPTION

The present disclosure relates generally to ultra-deep azimuthal resistivity logging. As described below, ultra-deep azimuthal resistivity (UDAR) tools have enabled deeper detection capabilities around a wellbore downhole. Additionally, two-dimensional (2D) and three-dimensional (3D) inversion algorithms have offered valuable formation insights by transforming UDAR measurements into resistivity profiles within the 3D space surrounding the wellbore. However, effectively representing 3D resistivity data in a clear and meaningful way presents a significant challenge, especially given the vast amount of data generated by 3D inversion from a single job or multiple jobs. Current visualization algorithms typically use an iso surface that represents points in a volume that share the same resistivity value or fall within a user-defined range. Another common approach, named volume slice planes, is plotting multiple 2D slice views along different planes. This disclosure aims to provide more effective techniques and visualization methods for extracting useful information from 3D resistivity inversion results.

The methods and systems proposed herein aim to provide meaningful geological features ahead of the tools based on inversion results, using dedicated 2D visualization along the radial direction surrounding an observation point. Additionally, a new approach to evaluate inversion uncertainty along any radial direction around the observation points is introduced, offering a novel way to quality check (QC) inversion results in 3D space. Additionally, methods and systems may reduce the data volume in visualizing 3D resistivity results by extracting useful information to accurately identify key features, such as layer boundaries and resistivity anomalies at specific locations, which are critical for geophysical interpretation and geosteering decisions. Additionally, it incorporates inversion uncertainty information to enhance decision-making accuracy.

Generally, in real formations, a resistivity of the formation varies in different directions, for example, a formation resistivity may vary in the x, y, and z coordinates. In electrically anisotropic formations, the anisotropy may be attributable to extremely fine layering during the sedimentary buildup of the formation. A formation Cartesian coordinate system may be oriented such that the x-y plane is parallel to the formation layers and the z axis is perpendicular to the formation layers. Resistivities measured in the x and y directions (e.g., Rx and Ry, respectively), may tend to be more similar relative to resistivity measured in the x direction (e.g., Rz). The resistivity in a direction parallel to the formation plane (i.e., the x-y plane) may be referred to as the horizontal resistivity, Rh, and the resistivity in the direction perpendicular to the plane of the formation (i.e., the z direction) may be referred to the vertical resistivity, Rv. Due to the geological processes which deposit and form lithified sedimentary depositions, it may be more common to see gradational lithological changes rather than abrupt lithological changes. Likewise, these changes may be reflected in the responses measured from a formation evaluation tool, such as an electromagnetic resistivity tool.

The raw measurements acquired with an electromagnetic resistivity tool (e.g., apparent resistivity) may be challenging to evaluate and/or interpret without the application of an inversion. An inversion may be a mathematical or statistical technique which incorporates forward modeling to recover plausible physical formation properties from raw measurements collected by a formation evaluation tool. Prior knowledge related to the formation in which the measurements were acquired may be incorporated into the forward modelling process in order to place boundaries around the potential interpretations (e.g., solutions) on which the forward model may converge. Additionally, the prior knowledge about the formation may create a range of potential inversion assumptions where any particular assumption in the range of assumptions may be associated with different statistical likelihoods of occurrence. As a result, an inversion may create a multitude of interpretations which may further be ranked according to their statistically likelihood of occurrence. Due to the statistical and iterative nature of an inversion calculation, dramatic departures or abrupt changes in the raw measurements (e.g., inputs to the inversion) collected by a formation evaluation tool (e.g., electromagnetic resistivity tool) may create unstable inversion solutions. While these abrupt changes may corrupt or obfuscate the formation properties in the geospatial vicinity where the data was collected, they may additionally indicate geologic discontinuities such as natural or man-made fractures and faults.

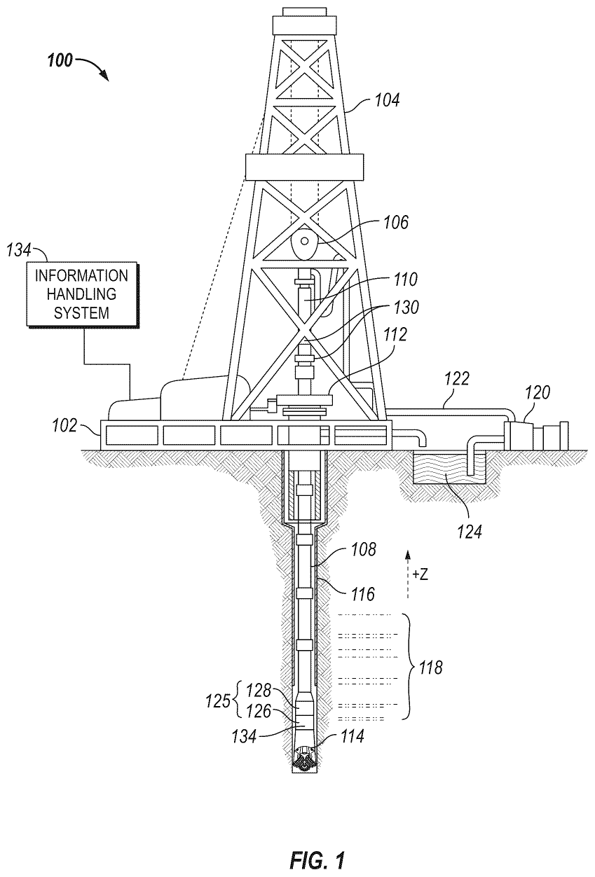

The disclosed apparatuses, systems and methods may be best understood in the context of the larger systems in which they operate. FIG. 1 illustrates a diagrammatic view of an exemplary logging while drilling (LWD) and/or measurement while drilling (MWD) well measurement system 100 in which the present disclosure may be implemented. As depicted in FIG. 1, a drilling platform 102 is equipped with a derrick 104 that supports a hoist 106 for raising and lowering a drill string 108. Hoist 106 suspends a top drive 110 suitable for rotating the drill string 108 and lowering the drill string 108 through the well head 112. Connected to the lower end of the drill string 108 is a drill bit 114. As drill bit 114 rotates, drill bit 114 creates a wellbore 116 that passes through various subterranean formation 118. A pump 120 circulates drilling fluid through a supply pipe 122 to top drive 110, down through the interior of drill string 108, through orifices in drill bit 114, back to the surface via the annulus around drill string 108, and into a retention pit 124. The drilling fluid transports cuttings from the wellbore 116 into retention pit 124 and aids in maintaining the integrity of the wellbore 116. Various materials can be used for drilling fluid, including oil-based fluids and water-based fluids.

As depicted in FIG. 1, logging tools 126 are integrated into the bottom-hole assembly 125 near drill bit 114. As the drill bit 114 extends wellbore 116 through the subterranean formation 118, logging tools 126 collect measurements relating to various formation properties as well as the orientation of the tool and various other drilling conditions. The bottom-hole assembly 125 may also include a telemetry sub 128 to transfer measurement data to a surface receiver 130 and to receive commands from the surface. In some embodiments, the telemetry sub 128 communicates with a surface receiver 130 using mud pulse telemetry. In other cases, the telemetry sub 128 does not communicate with the surface, but rather stores logging data for later retrieval at the surface when the logging assembly is recovered. Notably, one or more of the bottom-hole assembly 125, the logging tools 126, and the telemetry sub 128 may also operate using a non-conductive cable (e.g., slickline, etc.) with a local power supply, such as batteries and the like. When employing non-conductive cable, communication may be supported using, for example, wireless protocols (e.g., EM, acoustic, etc.) and/or measurements and logging data may be stored in local memory for subsequent retrieval at the surface, as is appreciated by those skilled in the art.

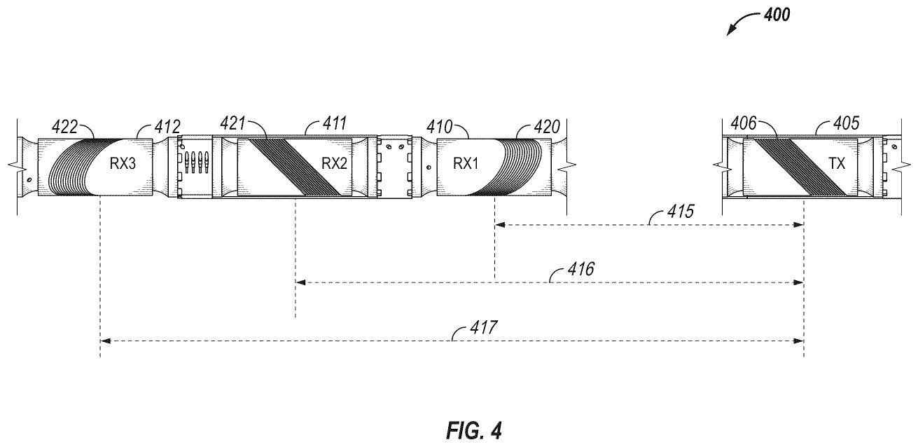

Each of the logging tools 126 may include a plurality of tool components, spaced apart from each other, and communicatively coupled with one or more wires. Logging tools 126 may include tools such as the one shown in FIG. 4 in order to perform resistivity, or conductivity logging. The telemetry sub 128 may include wireless telemetry or logging capabilities, or both, such as to transmit or later provide information indicative of received energy/waveforms to operators on the surface or for later access and data processing for the evaluation of formation 118 properties.

Further, bottom-hole assembly 125 may include a telemetry sub to maintain a communications link with the surface (e.g., with information handling system 134). Such telemetry communications may be used for (i) transferring tool measurement data from bottom-hole assembly (BHA) 125 to surface receivers, and/or (ii) receiving commands (from the surface) to bottom-hole assembly 125 (e.g., for use of one or more tool(s) in bottom-hole assembly 125). In examples, telemetry communications may be at least in part between bottom-hole assembly 125 and information handling system 134. Additionally, information handling system 134 may be disposed at surface and communication with bottom-hole assembly 125 as well as logging tool 126 and/or telemetry sub 128.

As illustrated, the information handling system 134 may comprise any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 134 may be a personal computer, a network storage device, or any other suitable device and may vary in size, shape, performance, functionality, and price.

Information handling system 134 may include a processing unit (e.g., microprocessor, central processing unit, etc.) that may process drilling data from rotary steerable system (RSS) which may be disposed on bottom-hole assembly 125, by executing software or instructions obtained from a local non-transitory computer readable media (e.g., optical disks, magnetic disks). The non-transitory computer readable media may store software or instructions of the methods described herein. Non-transitory computer readable media may include any instrumentality or aggregation of instrumentalities that may retain data and/or instructions for a period of time. Non-transitory computer readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 134 may also include input device(s) (e.g., keyboard, mouse, touchpad, etc.) and output device(s) (e.g., monitor, printer, etc.). The input device(s) and output device(s) provide a user interface that enables an operator to interact with any device disposed or a part of bottom-hole assembly 125, discussed below, and/or software executed by a processing unit. For example, information handling system 134 may enable an operator to select analysis options, view collected log data, view analysis results, and/or perform other tasks.

Non-limiting examples of techniques for transferring tool measurement data (to the surface) include mud pulse telemetry and through-wall acoustic signaling. For through-wall acoustic signaling, one or more repeater(s) may detect, amplify, and re-transmit signals from bottom-hole assembly 125 to the surface (e.g., to information handling system 134), and conversely, from the surface (e.g., from information handling system 134) to bottom-hole assembly 125.

A repeater is a device which may be used to receive and send signals from one component of well measurement system 100 to another component of well measurement system 100. As a non-limiting example, repeater may be used to receive a signal from a tool on bottom-hole assembly 125 and send that signal to information handling system 134. Two or more repeaters may be used together, in series, such that a signal to/from bottom-hole assembly 125 may be relayed through two or more repeaters before reaching its destination.

In some embodiments, one or more of the logging tools 126 may communicate with a surface receiver 130, such as a wired drill pipe. In other cases, one or more of the logging tools 126 may communicate with a surface receiver 130 by wireless signal transmission. Surface receiver 130 may further transfer data received to information handling system 134. Additionally information handling system 134 may use surface receiver 130 to communicate with logging tools 126. In at least some cases, one or more of the logging tools 126 may receive electrical power from a wire that extends to the surface, including wires extending through a wired drill pipe. In at least some instances the methods and techniques of the present disclosure may be performed by a computing device (not shown) on the surface. In some embodiments, the computing device may be included in surface receiver 130. For example, surface receiver 130 of well measurement system 100 at the surface may include one or more of wireless telemetry, processor circuitry, or memory facilities, such as to support substantially real-time processing of data received from one or more of the logging tools 126. In some embodiments, data is processed at some time subsequent to its collection, wherein the data may be stored on the surface at surface receiver 130, stored downhole in telemetry sub 128, or both, until it is retrieved for processing.

Additionally, communications may be performed at least in part by a transducer. A transducer is a device which may be configured to convert non-digital data (e.g., vibrations, other analog data) into a digital form suitable for information handling system 134. As a non-limiting example, one or more transducer(s) may convert signals between mechanical and electrical forms, enabling information handling system 134 to receive the signals from a telemetry sub, on bottom-hole assembly 125, and conversely, transmit a downlink signal to the telemetry sub on bottom-hole assembly 125. In any embodiment, transducer may be located at the surface and/or any part of drill string 108 (e.g., as part of bottom-hole assembly 125).

Drill bit 114 is a machine which may be used to cut through, scrape, and/or crush (i.e., break apart) materials in the ground (e.g., rocks, dirt, clay, etc.). Drill bit 114 may be disposed at the frontmost point of drill string 108 and bottom-hole assembly 125. In any embodiment, drill bit 114 may include one or more cutting edges (e.g., hardened metal points, surfaces, blades, protrusions, etc.) to form a geometry which aids in breaking ground materials loose and further crushing that material into smaller sizes. In any embodiment, drill bit 114 may be rotated and forced into (i.e., pushed against) the ground material to cause the cutting, scraping, and crushing action. The rotations of drill bit 114 may be caused by top drive 110 and/or one or more motor(s) located on drill string 108 (e.g., on bottom-hole assembly 125).

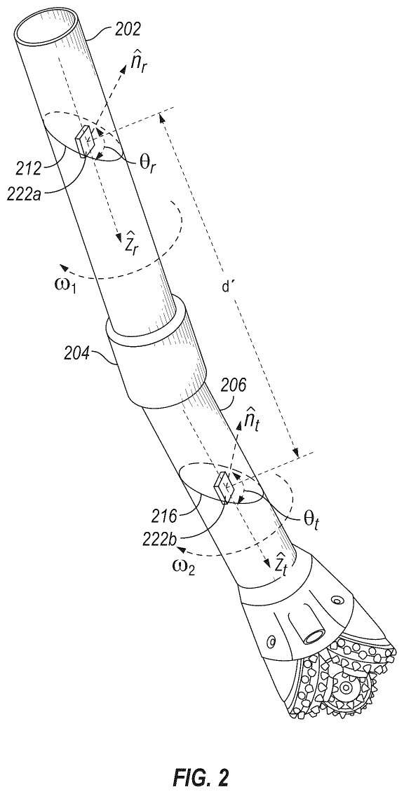

FIG. 2 shows an illustrative example of a deep formation evaluation logging tool that includes two LWD tool modules 202 and 206 at different locations and orientations along a drill string. In the example shown, a resistivity logging tool receive antenna 212 and a corresponding receive antenna position measurement device 222 a may be housed within LWD tool module 202, while a resistivity logging tool transmit antenna 216 and a corresponding transmit antenna position measurement device 222 b (components of an “at bit” instrument) are housed within LWD tool module 206. The position measurement devices may locate the position of each corresponding antenna, which may be expressed, for example, in terms of each antenna's tilt angle (θᵣ and θₜ relative to the zᵣ and zₜ axes respectively; generally fixed and known), each antenna's azimuthal angle (αᵣ and αₜ relative to the x axis), each LWD tool module's inclination angle (φᵣ and φₜ) and the distance d′ between the antennas. Various methods may be used to locate the antenna positions (e.g., relative to a reference position on the surface), several of which are described in more detail below. It should be noted that although the bent sub angles are typically less than five degrees, the figures show much more pronounced angles to better illustrate the effect of the angles on the relative spatial locations of the antennas, described in more detail below.

The above-described antenna and LWD tool module orientations may be used to calibrate tool responses prior to performing an inversion process to model the surrounding formation. Such calibration is performed in order to be able to compare the modeled and measure results, as the modeled results assume known and fixed orientations and spatial locations of the resistivity logging tool transmit and receive antennas relative to each other, but the measured results may originate from antennas with any of a number of different relative orientations and spatial locations other than those presumed in the model. Measured and modeled results may be in the form of complex voltages, complex currents, resistivity values derived from measured/modeled voltages and/or currents, and/or ratios of voltages, currents and/or resistivities, just to name a few examples. Part of this calibration can be performed mathematically as one or more matrix rotations, while another part may be performed as a derivation of the relative spatial locations of and/or distance between antennas based on the antennas' locations and orientations. The resulting calibrated response is provided to the inversion, which uses these inputs to model the formation.

Equation (1), expressed more simply in equation (2), illustrates the rotation portion of the calibration process, taking into account each of the above-described angles:

$${V}_{R}^{T} ( {t}_{0} ) = {[ \begin{matrix}sin ( {θ}_{t} + {∅}_{t} ( {t}_{0} ) ) cos ( {∝}_{t} ( {t}_{0} ) ) \\ sin ( {θ}_{t} + {∅}_{t} ( {t}_{0} ) ) sin ( ∝ ( {t}_{0} ) ) \\ cos ( {θ}_{t} + {∅}_{t} ( {t}_{0} ) )\end{matrix} ]}^{T} [ \begin{matrix}{V}_{x}^{x} ( {t}_{0} ) & {V}_{y}^{x} ( {t}_{0} ) & {V}_{z}^{x} ( {t}_{0} ) \\ {V}_{x}^{y} ( {t}_{0} ) & {V}_{y}^{y} ( {t}_{0} ) & {V}_{z}^{y} ( {t}_{0} ) \\ {V}_{x}^{z} ( {t}_{0} ) & {V}_{y}^{z} ( {t}_{0} ) & {V}_{z}^{z} ( {t}_{0} )\end{matrix} ] [ \begin{matrix}sin ( {θ}_{r} + {∅}_{t} ( {t}_{0} ) ) cos ( {∝}_{r} ( {t}_{0} ) ) \\ sin ( {θ}_{r} + {∅}_{r} ( {t}_{0} ) ) sin ( {∝}_{r} ( {t}_{0} ) ) \\ cos ( {θ}_{r} + {∅}_{r} ( {t}_{0} ) )\end{matrix} ] \qquad ( 1 )$$

$${V}_{R}^{T} ( {t}_{0} ) = {T}_{VECTOR}^{T} ( {t}_{0} ) * {V}_{MATRIX} ( {t}_{0} ) * {R}_{VECTOR} ( {t}_{0} ) \qquad ( 2 )$$

where

$${T}_{VECTOR}^{T} ( {t}_{0} )$$

(shown in transposed form for convenience) is given by the transmit antenna's known tilt angle θₜ, and by the inclination angle Øₜ and azimuthal angle ∝ₜ as determined by the transmit antenna's position measurement device at time t₀; R_{VECTOR}(t₀) is given by the receive antenna's known tilt angle θᵣ, and by the inclination angle Øᵣ azimuthal angle ∝ᵣ as determined by the receive antenna's position measurement device at time t₀; and V_{MATRIX}(t₀) is a 3×3 voltage matrix consisting of nine components

$${V}_{j}^{i} .$$

Each component represents a theoretical voltage a receive antenna with a j axis orientation (x, y or z) in response to a signal from a transmit antenna with an i axis orientation (also x, y or z) for a given formation model, operating frequency and spacing d′.

Another part of the calibration may involve determining the distance between the transmit antenna and the receive antenna. The distance between transmit and receive antennas changes when two or more LWD tool modules are positioned such that they no longer share a common z axis. For example, in FIG. 2 both LWD tool modules 202 and 206 are inclined such that each z axis (zᵣ and zₜ) is inclined at a different inclination angle φ (φᵣ and φₜ) relative to a vertical reference z axis. The inclination angle change reduces the original distance between the receive and transmit antennas 212 and 216 from original distance d when the drillstring was straight (bent sub 204 set to 0 degrees) to distance d′.

As a further complication to measuring formation resistivity, boreholes are generally perpendicular to formation beds. The angle between the axis of the well bore and the orientation of the formation beds (as represented by the normal vector) has two components. These components are the dip angle and the azimuth angle. The dip angle is the angle between the borehole axis and the normal vector for the formation bed. The azimuth angle is the direction in which the borehole's axis “leans away from” the normal vector. Electromagnetic resistivity logging measurements are a complex function of formation resistivity, formation anisotropy, and the formation dip and azimuth angles, which may all be unknown. A triaxial induction well logging tool may be used to detect formation properties such as resistivity anisotropy, which is one of the important parameters in evaluation subterranean formations such as sand-shale reservoirs or fractured reservoirs. However, the resistivity anisotropy parameter cannot be obtained without performing a numerical inversion process. Specifically, numerical inversion may be utilized to obtain accurate formation resistivity anisotropy parameters. The log inversion utilized for anisotropy determination may involve a large number of inversion parameters to be determined by an algorithm referred to as the ID vertical inversion. Generally, this algorithm may utilize large amounts of processing time and be sensitive to noise from logging, the logging environment characteristics and borehole correction, which could result in errors in the inverted vertical resistivity.

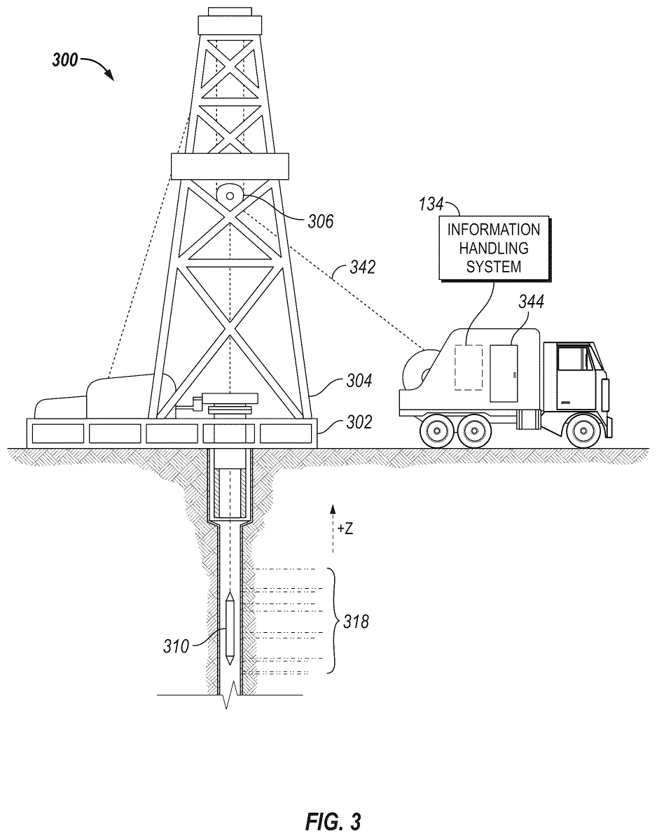

FIG. 3 illustrates a diagrammatic view of a conveyance logging wellbore operating environment 300 in which the present disclosure may be implemented. As depicted in FIG. 3, a hoist 306 may be included as a portion of a platform 302, such as that coupled to derrick 304, and used with a conveyance 342 to raise or lower equipment such as resistivity logging tool 310 into or out of a borehole. Resistivity logging tool 310 may include, for example, tools such as the one shown in FIG. 4. A conveyance 342 may provide a communicative coupling between the resistivity logging tool 310 and a logging facility 344 at the surface. The conveyance 342 may include wires (one or more wires), slicklines, cables, or the like, as well as tubular conveyances such as coiled tubing, joint tubing, or other tubulars, and may include a downhole tractor. Additionally, power may be supplied via conveyance 342 to meet power needs of the tool. The resistivity logging tool 310 may have a local power supply, such as batteries, downhole generator and the like. When employing non-conductive cable, coiled tubing, pipe string, or downhole tractor, communication may be supported using, for example, wireless protocols (e.g., EM, acoustic, etc.), and/or measurements and logging data may be stored in local memory for subsequent retrieval. Logging facility 344 may include information handling system 134 capable of carrying out the methods and techniques of the present disclosure. In this manner, information about the formation 318 may be obtained by resistivity logging tool 310 and processed by a computing device, such as information handling system 134. In some embodiments, information handling system 134 is equipped to process the received information in substantially real-time, while in some embodiments, information handling system 134 can be equipped to store the received information for processing at some subsequent time.

FIG. 4 illustrates an example wellbore tool 400 that may be used in the systems and methods described herein. Wellbore tool 400 may comprise transmitter sub 405 and one or more receiver subs 410, 411, and 412. In some examples, transmitter sub 405 may be referred to as TX and receiver subs 410, 411, and 412 may be referred to as RX1, RX2, and RX3 respectively. Transmitter sub 405 may comprise a transmitter coil 406 which may be an electromagnetic wave source such as a monopole, dipole, quadrupole, or other higher order wave source. Each of the receiver subs 410, 411, and 412 may comprise three or more receiver coils per sub configured to receive an electromagnetic wave from transmitter sub 405. Receiver subs 410, 411, and 412 may be disposed on wellbore tool 400 a distance 415, 416, 417 from transmitter sub1 05. Distance 415, 416, 417 may also be referred to as S1, S2, and S3 respectively.

Referring to FIG. 4 and FIG. 2, first receiver coils 420 are not co-axial with receiver sub 410. There may be an axial offset between first receiver coils 420 and a centerline of receiver sub 410 which may be notated as θ_{R1}. Similarly, for transmitter coil 406, second receiver coils 421, and third receiver coils 422, there may be an axial offset of coils from a centerline of the respective subs notated as θ_{T}, θ_{R2}, and θ_{R3} respectively. In addition to axial offset, each of the first receiver coils 420, second receiver coils 421, and third receiver coils 422 may have an azimuthal offset relative to transmitter coil 406. The tilt angle of the transmitter coil is notated as θ_{T} and the tilt angle, or azimuthal offset, of each of the receiver coils is notated as θ_{R1}, θ_{R2}, and θ_{R3} for RX1, RX2, and RX3 respectively. The azimuth angle is dependent on wellbore tool's 400 rotated position in wellbore 116 (e.g., referring to FIG. 1). In examples, although not illustrated, β_{off} is the difference in azimuthal angle between the transmitter coil and the second receiver coil which may be measured before the tool is inserted into wellbore 116. Further, β_{Δ1} is the difference in azimuthal angle between the first receiver coil 420 and the second receiver coil 421 and β_{Δ2} is the difference in azimuthal angle between the third receiver coil 422 and second receiver coil 420. In examples, variables β_{Δ1} and β_{Δ2} may take any value but may follow the following parameters: (1) β_{Δ1}+β_{Δ2}, (2) β_{Δ1}+0°, and (3) β_{Δ2}≠0°.

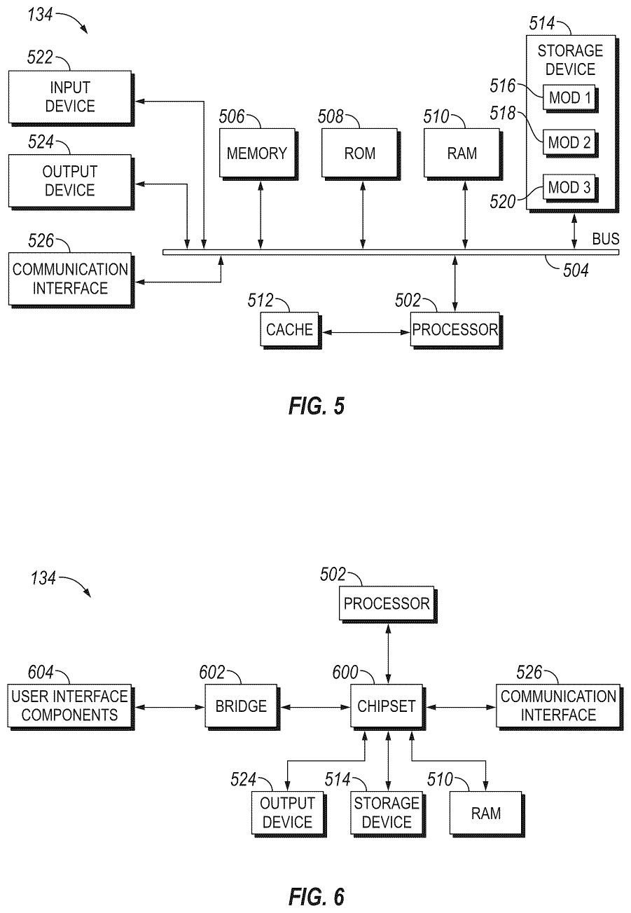

FIG. 5 further illustrates an example information handling system 134 which may be employed to perform various steps, methods, and techniques disclosed herein. Persons of ordinary skill in the art will readily appreciate that other system examples are possible. As illustrated, information handling system 134 includes a processing unit (CPU or processor) 502 and a system bus 504 that couples various system components including system memory 506 such as read only memory (ROM) 508 and random-access memory (RAM) 510 to processor 502. Processors disclosed herein may all be forms of this processor 502. Information handling system 134 may include a cache 512 of high-speed memory connected directly with, in close proximity to, or integrated as part of processor 502. Information handling system 134 copies data from memory 506 and/or storage device 514 to cache 512 for quick access by processor 502. In this way, cache 512 provides a performance boost that avoids processor 502 delays while waiting for data. These and other modules may control or be configured to control processor 502 to perform various operations or actions. Other system memory 506 may be available for use as well. Memory 506 may include multiple different types of memory with different performance characteristics. It may be appreciated that the disclosure may operate on information handling system 134 with more than one processor 502 or on a group or cluster of computing devices networked together to provide greater processing capability. Processor 502 may include any general-purpose processor and a hardware module or software module, such as first module 516, second module 518, and third module 520 stored in storage device 514, configured to control processor 502 as well as a special-purpose processor where software instructions are incorporated into processor 502. Processor 502 may be a self-contained computing system, containing multiple cores or processors, a bus, memory controller, cache, etc. A multi-core processor may be symmetric or asymmetric. Processor 502 may include multiple processors, such as a system having multiple, physically separate processors in different sockets, or a system having multiple processor cores on a single physical chip. Similarly, processor 502 may include multiple distributed processors located in multiple separate computing devices but working together such as via a communications network. Multiple processors or processor cores may share resources such as memory 506 or cache 512 or may operate using independent resources. Processor 502 may include one or more state machines, an application specific integrated circuit (ASIC), or a programmable gate array (PGA) including a field PGA (FPGA).

Each individual component discussed above may be coupled to system bus 504, which may connect each and every individual component to each other. System bus 504 may be any of several types of bus structures including a memory bus or memory controller, a peripheral bus, and a local bus using any of a variety of bus architectures. A basic input/output (BIOS) stored in ROM 508 or the like, may provide the basic routine that helps to transfer information between elements within information handling system 134, such as during start-up. Information handling system 134 further includes storage devices 514 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 514 may include software modules 516, 518, and 520 for controlling processor 502. Information handling system 134 may include other hardware or software modules. Storage device 514 is connected to the system bus 504 by a drive interface. The drives and the associated computer-readable storage devices provide nonvolatile storage of computer-readable instructions, data structures, program modules and other data for information handling system 134. In one aspect, a hardware module that performs a particular function includes the software component stored in a tangible computer-readable storage device in connection with hardware components, such as processor 502, system bus 504, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 134 is a small, handheld computing device, a desktop computer, or a computer server. When processor 502 executes instructions to perform “operations”, processor 502 may perform the operations directly and/or facilitate, direct, or cooperate with another device or component to perform the operations.

As illustrated, information handling system 134 employs storage device 514, which may be a hard disk or other types of computer-readable storage devices which may store data that are accessible by a computer, such as magnetic cassettes, flash memory cards, digital versatile disks (DVDs), cartridges, random access memories (RAMs) 510, read only memory (ROM) 508, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 134, an input device 522 represents any number of input mechanisms, such as a microphone for speech, a touch-sensitive screen for gesture or graphical input, keyboard, mouse, motion input, speech and so forth. Additionally, input device 522 may receive one or more measurements from bottom-hole assembly 125 (e.g., referring to FIG. 1), discussed above. An output device 524 may also be one or more of a number of output mechanisms known to those of skill in the art. In some instances, multimodal systems enable a user to provide multiple types of input to communicate with information handling system 134. Communications interface 526 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 502, that is purpose-built to operate as an equivalent to software executing on a general-purpose processor. For example, the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 508 for storing software performing the operations described below, and random-access memory (RAM) 510 for storing results. Very large-scale integration (VLSI) hardware embodiments, as well as custom VLSI circuitry in combination with a general-purpose DSP circuit, may also be provided.

FIG. 6 illustrates an example information handling system 134 having a chipset architecture that may be used in executing the described method and generating and displaying a graphical user interface (GUI). Information handling system 134 is an example of computer hardware, software, and firmware that may be used to implement the disclosed technology. Information handling system 134 may include a processor 502, representative of any number of physically and/or logically distinct resources capable of executing software, firmware, and hardware configured to perform identified computations. Processor 502 may communicate with a chipset 600 that may control input to and output from processor 502. In this example, chipset 600 outputs information to output device 524, such as a display, and may read and write information to storage device 514, which may include, for example, magnetic media, and solid-state media. Chipset 600 may also read data from and write data to RAM 510. A bridge 602 for interfacing with a variety of user interface components 604 may be provided for interfacing with chipset 600. Such user interface components 604 may include a keyboard, a microphone, touch detection and processing circuitry, a pointing device, such as a mouse, and so on. In general, inputs to information handling system 134 may come from any of a variety of sources, machine generated and/or human generated.

Chipset 600 may also interface with one or more communication interfaces 526 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 502 analyzing data stored in storage device 514 or RAM 510. Further, information handling system 134 receives inputs from a user via user interface components 604 and executes appropriate functions, such as browsing functions by interpreting these inputs using processor 502.

In examples, information handling system 134 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

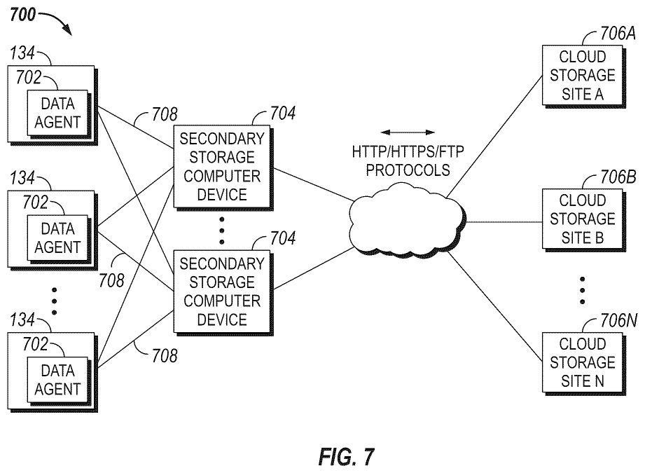

FIG. 7 illustrates an example of one arrangement of resources in a computing network 700 that may employ the processes and techniques described herein, although many others are of course possible. As noted above, an information handling system 134, as part of their function, may utilize data, which includes files, directories, metadata (e.g., access control list (ACLS) creation/edit dates associated with the data, etc.), and other data objects. The data on the information handling system 134 is typically a primary copy (e.g., a production copy). During a copy, backup, archive or other storage operation, information handling system 134 may send a copy of some data objects (or some components thereof) to a secondary storage computing device 704 by utilizing one or more data agents 702.

A data agent 702 may be a desktop application, website application, or any software-based application that is run on information handling system 134. As illustrated, information handling system 134 may be disposed at any rig site (e.g., referring to FIG. 1), off site location, or repair and manufacturing center. The data agent may communicate with a secondary storage computing device 704 using communication protocol 708 in a wired or wireless system. Communication protocol 708 may function and operate as an input to a website application. In the website application, field data related to pre- and post-operations, generated DTCs, notes, and the like may be uploaded. Additionally, information handling system 134 may utilize communication protocol 708 to access processed measurements, operations with similar DTCs, troubleshooting findings, historical run data, and/or the like. This information is accessed from secondary storage computing device 704 by data agent 702, which is loaded on information handling system 134.

Secondary storage computing device 704 may operate and function to create secondary copies of primary data objects (or some components thereof) in various cloud storage sites 706A-N. Additionally, secondary storage computing device 704 may run determinative algorithms on data uploaded from one or more information handling systems 134, discussed further below. Communications between the secondary storage computing devices 704 and cloud storage sites 706A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 706A-N, the secondary storage computing device 704 may also perform local content indexing and/or local object-level, sub-object-level or block-level deduplication when performing storage operations involving various cloud storage sites 706A-N. Cloud storage sites 706A-N may further record and maintain, EM logs, map DTC codes, store repair and maintenance data, store operational data, and/or provide outputs from determinative algorithms that are located in cloud storage sites 706A-N. In a non-limiting example, this type of network may be utilized as a platform to store, backup, analyze, import, preform extract, transform and load (“ETL”) processes, mathematically process, apply machine learning models, and augment EM measurement data sets.

A machine learning model may be an empirically derived model which may result from a machine learning algorithm identifying one or more underlying relationships within a dataset. In comparison to a physics-based model, such as Maxwell's Equations, which are derived from first principles and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “target values.” Although dependent values may be a component of a dataset for certain algorithms, not all algorithms may utilize a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may include evaluating model performance according to whether the model is over-fit or under-fit. As it may be assumed that all datasets contain some level of error, it may be important to evaluate and optimize the model performance and associated model fit by a model validation. In general, the variability in model fit (e.g.: whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods include k-fold cross-validation, stratified k-fold cross-validation, bootstrapping, leave-one-out cross-validation, resubstituting, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may include the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may include whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset includes both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may include Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not include a dependent variable as the intended function of this type of algorithm is to identify one or more groupings or clusters within a dataset. In a non-limiting example, algorithms which may be utilized for unsupervised machine learning may include K-means clustering, K-means classification, Fuzzy C-Means, Gaussian Mixture, Hidden Markov Model, Neural Networks, and Hierarchical algorithms.

In examples to determine a relationship using machine learning, a neural network (NN) 800, as illustrated in FIG. 8, may be utilized to model a three-dimensional finite element BHA to analyze lateral deflection experienced by bottom-hole assembly 125 (e.g., referring to FIG. 1) in both its lateral deflection in both inclination and pseudo-azimuth planes in a curved wellbore 116 (e.g., referring to FIG. 1). FIG. 8 illustrates neural network (NN) 800. NN 800 may operate utilizing one or more information handling systems 134 (e.g., referring to FIG. 1) on computing network 700. Although a NN is illustrated, multiple models may be used with input output structures. These models may include flexible empirical models such as NN, gaussian processing methods, kriging methods, evolutionary methods such as genetic algorithms, classification methods, clustering methods empirical methods, or physics based methods such as equations of state, thermodynamic models, geological, geochemistry, or chemistry models, or kinetic models or any combinations therein including recursive combinations of similar or dissimilar models and iterative model combinations. A NN 800 is an artificial neural network with one or more hidden layers 802 between input layer 804 and output layer 806. In examples, NN 800 may be software on a single information handling system 134. In other examples, NN 800 may software running on multiple information handling systems 134 connected wirelessly and/or by a hard-wired connection in a network of multiple information handling systems 134. Herein, NN 800 may be applied in a wide array of implementations.

During operations, inputs 808 data are given to neurons 812 in input layer 804. Neurons 812, 814, and 816 are defined as individual or multiple information handling systems 134 connected in a computing network 700. The output from neurons 812 may be transferred to one or more neurons 814 within one or more hidden layers 802. Hidden layers 802 includes one or more neurons 814 connected in a network that further process information from neurons 812. The number of hidden layers 802 and neurons 812 in hidden layer 802 may be determined by personnel that designs NN 800. Hidden layers 802 is defined as a set of information handling system 134 assigned to specific processing. Hidden layers 802 spread computation to multiple neurons 812, which may allow for faster computing, processing, training, and learning by NN 800. Output from NN 800 may be computed by neurons 816. An information handling system 134 (e.g., referring to FIG. 1) being utilized in a computing network 700, NN 800, or alone may control measurement operations downhole with well measurement system 100 (e.g., referring to FIGS. 1&2). Measurements taken by well measurement system 100 may be utilized by information handling system 134 with or without a computing network 700 or NN 800, as described above, to form two-dimensional (2D) or three-dimensional (3D) images. As disclosed below, methods and systems may be utilized to reduce the data volume in visualizing 3D formation electrical properties, such as resistivity measurements, from electromagnetic (EM) measurements taken during measurement operations, by extracting useful information to accurately identify key features, such as layer boundaries and resistivity anomalies at specific locations, which may be utilized for geophysical interpretation and geosteering decisions. Additionally, it incorporates inversion uncertainty information to enhance decision-making accuracy.

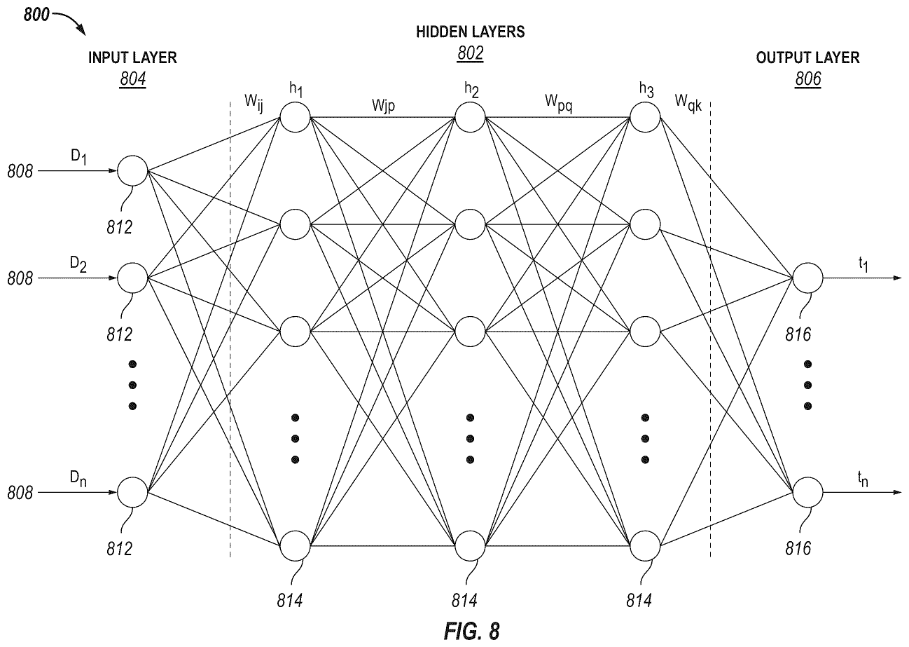

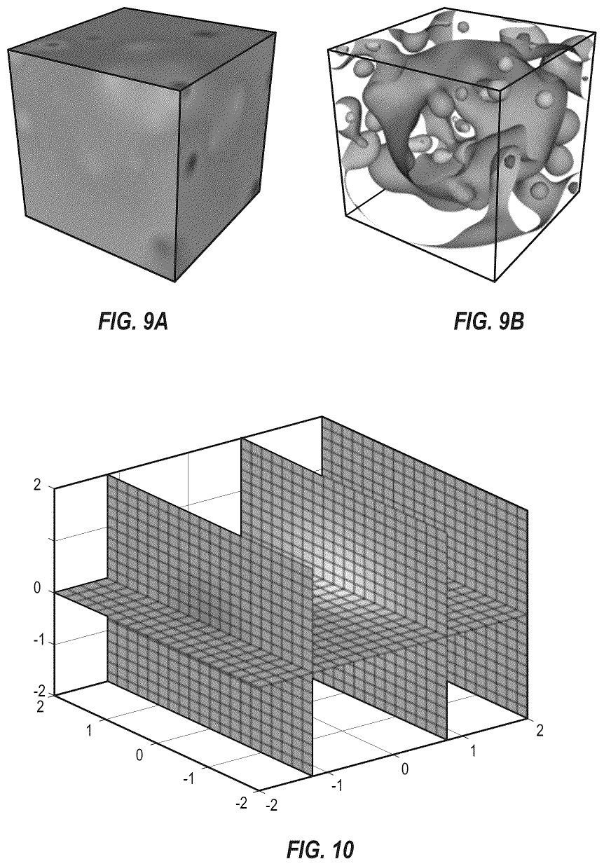

FIGS. 9A and 9B are graphs that illustrate current visualization techniques for 3D representation of formation electrical properties. FIG. 9A is a graph of visualization that fails to provide any meaningful information, while FIG. 9B is a graph of visualization that utilizes grouping sections with similar resistivity ranges. However, neither visualization method is particularly useful or easy to interpret for making geosteering decisions.

FIG. 10 is a graph that illustrates another 3D visualization of formation electrical properties, such as resistivity, from EM measurements taken by well measurement system 100. As illustrated, the graph in FIG. 10 is using volume slice planes 1000. As orthogonal planes are used in this approach, it may only provide us with very limited information about the surrounding 3D resistivity in azimuthal distributions. Additionally, such azimuthal distributions are indispensable for making geosteering decisions.

FIG. 11 illustrates a well measurement system 100 taking one or more measurements from observation point 1100 of formation 118 in a window 1102 of drilling direction 1104. Measurements taken within window 1102 may be analyzed and visualized as 3D formation electrical properties. As disclosed below 2D information may be extracted from 3D formation electrical properties. As illustrated in FIG. 11, window 1102 may comprise a 2D curved plane, which may be visualized as a 2D curved image on an information handling system 134, to visualize formation electrical properties in a 3D space that shares the same radial distance but varies in an azimuthal direction from observation point 1100. The 2D information may provide insights for evaluating profiles of formation 118 at a fixed distance from the observation point 1100, aiding in decision-making to steer drill bit 114 toward a specific azimuthal direction ahead of well measurement system 100.

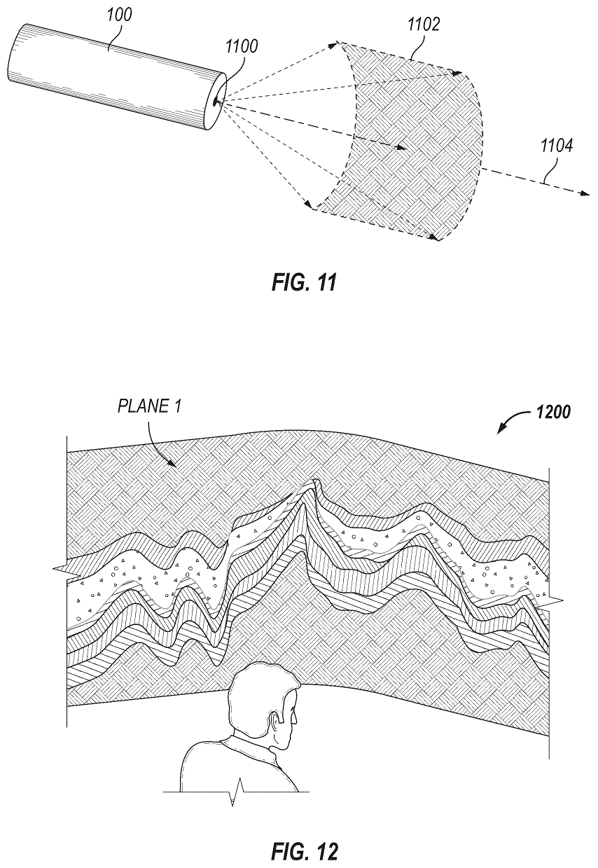

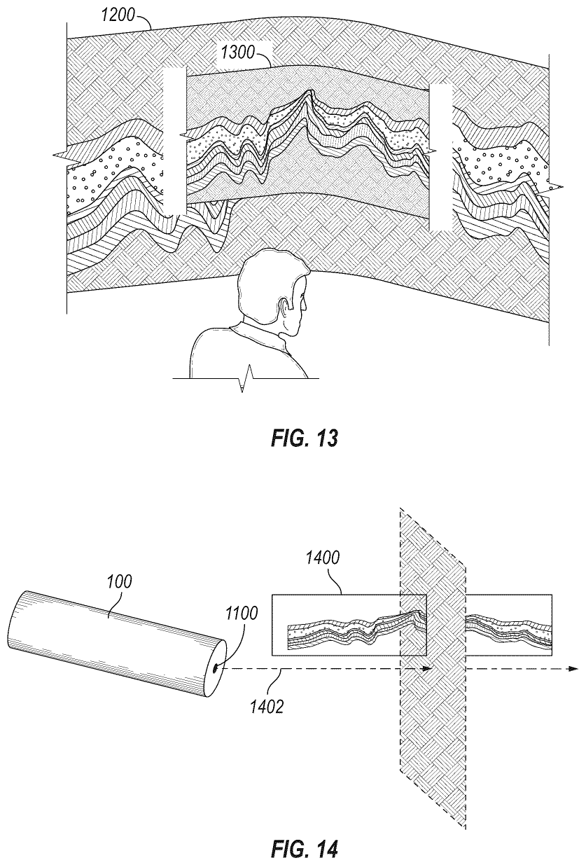

FIG. 12 illustrates a synthetic example of how such 2D information may be evaluated. Additionally, users may select planes at varying distances from observation point 1100 (e.g., referring to FIG. 11), as demonstrated by Plane 1200 and Plane 1300 in FIG. 13. These visualizations may allow for making real-time geosteering decisions ahead of drill bit 114 in horizontal look-ahead scenarios or generic look-ahead applications, such as landing or vertical wells.

Additionally, outside of visualizing 3D formation electrical properties, multiple values for formation electrical properties may exist at the same location when using Monte Carlo or stochastic inversion approaches. These methods generate various possible inverted solutions, in an uncertainty graph, from the same input dataset, allowing for a better assessment of inversion uncertainty. If the solutions are similar to one another, the inversion results have high confidence. Conversely, greater differences among the solutions indicate higher inversion uncertainty.

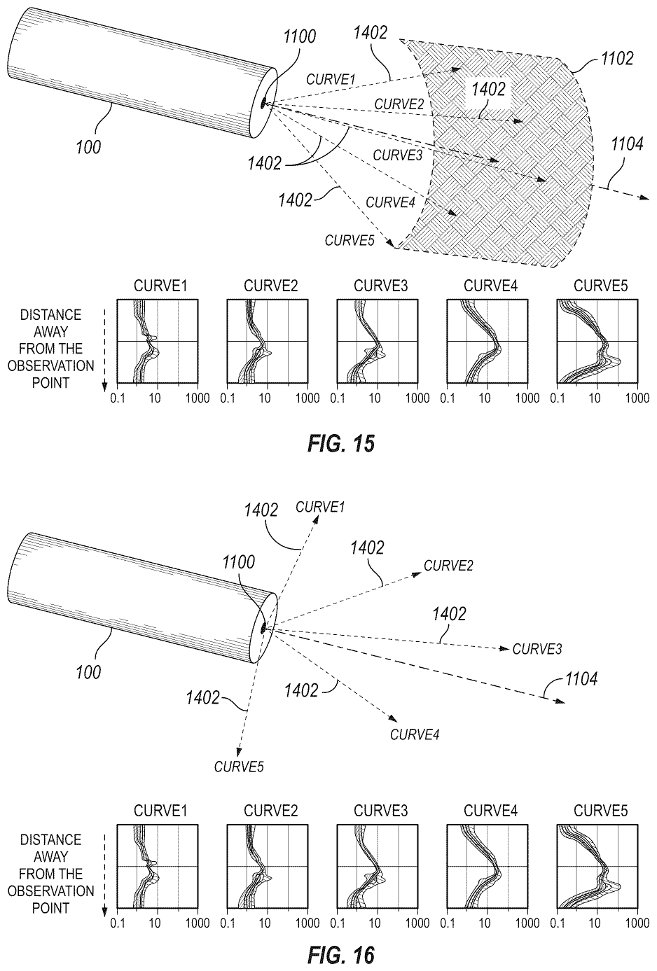

FIG. 14 visualizes inversion uncertainty using graph. As illustrated, FIG. 14 shows a graph 1400 that displays all possible inversion solutions along an azimuthal direction 1402, extracting 2D inversion results at a fixed distance from observation point 1100 of well measurements system 100. This enables users to evaluate inversion confidence at various distances from observation point 1100 for a single azimuthal/inclination direction. Users may also review inversion distributions across different azimuthal directions 1402 from observation point 1100 of well measurement system 100, as shown in FIGS. 15 and 16. The distance from observation point 1100 to location of interest may have an equal distance for each azimuthal direction 1402. However, each distance from observation point 1100 to a location of interest may have different distance for each azimuthal direction 1402. Other forms of graphing uncertainty may also be employed.

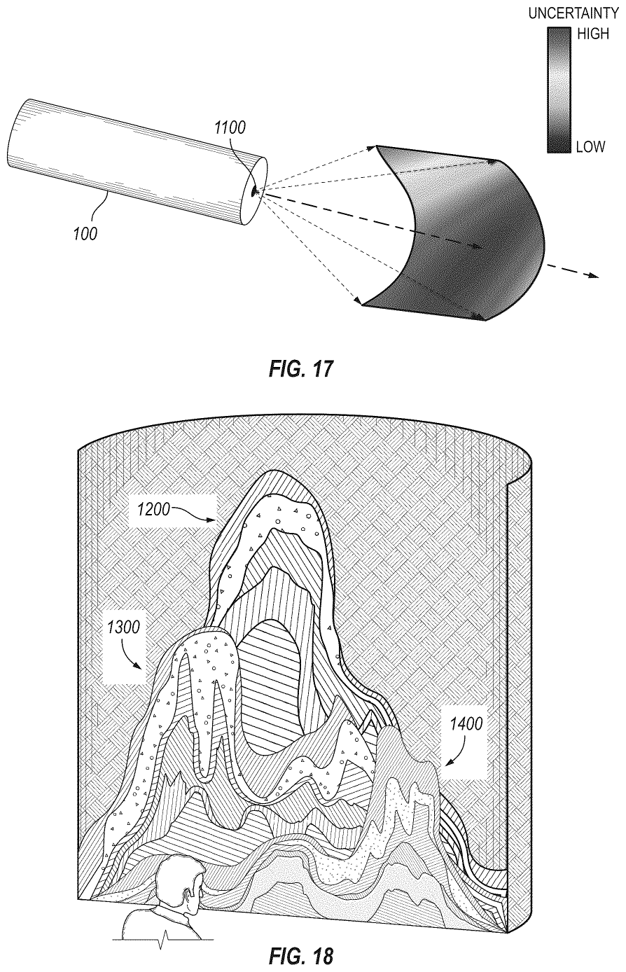

FIG. 17 illustrates a 2D curved plane, which may be visualized as a 2D curved image on an information handling system 134, to depict the estimated uncertainty at a fixed distance away from an observation point 1100 on well measurement system 100. These uncertainties may further be utilized to prepare a synthetic graph in FIG. 18 to plot estimated uncertainties at either a single distance or several distances. Additionally, both the resistivity profile and associated uncertainties may be combined into a single 2D curved plane, which may be visualized as a 2D curved image on an information handling system 134. For example, regions with higher uncertainties may be filtered out from view and only confident directions may be focused on. As noted above, machine learning (ML) algorithms may be applied using NN 800 to the 3D data to automatically detect formation electrical properties, such as resistivity boundaries, relative to other formation electrical properties, such as formation resistivity, at observation point 1100. These boundaries may be represented in a 1D view.

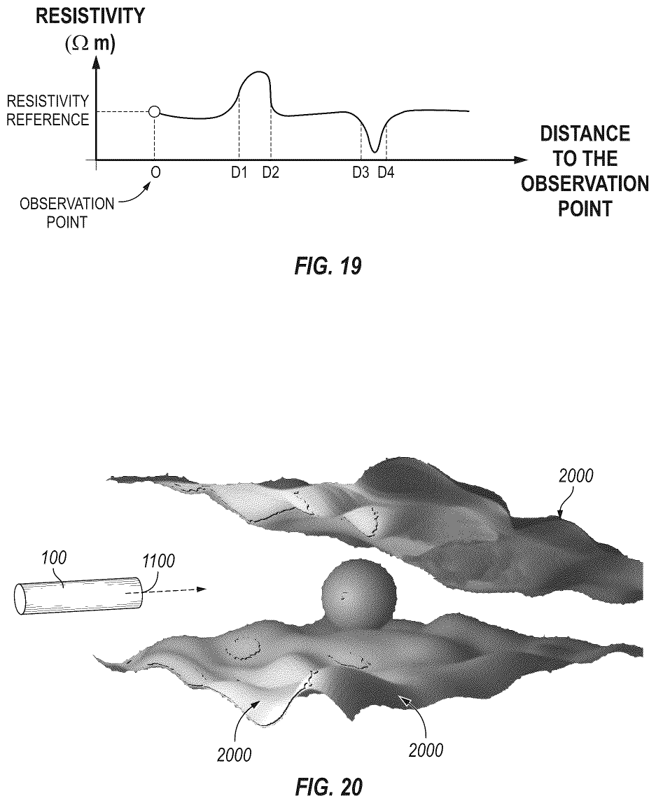

FIG. 19 is a graph of a one-dimensional (1D) log for formation electrical properties. In this example, the formation electrical properties values at observation point 1100 serves as a reference. The ML algorithms may then identify variations relative to this reference value, along with the corresponding boundary locations. In this case, D1 and D2 indicate boundaries where the formation electrical properties transitions to higher values, while D3 and D4 mark boundaries where the formation electrical properties decreases. Using the 1D graph and identifying boundaries of formation electrical property transition, information handling system 134 (e.g., referring to FIGS. 1 & 2) used in a computer network 700 and/or NN 800 (e.g., referring to FIGS. 7 & 8) may visualize the boundaries of formation electrical properties in a 3D plane.

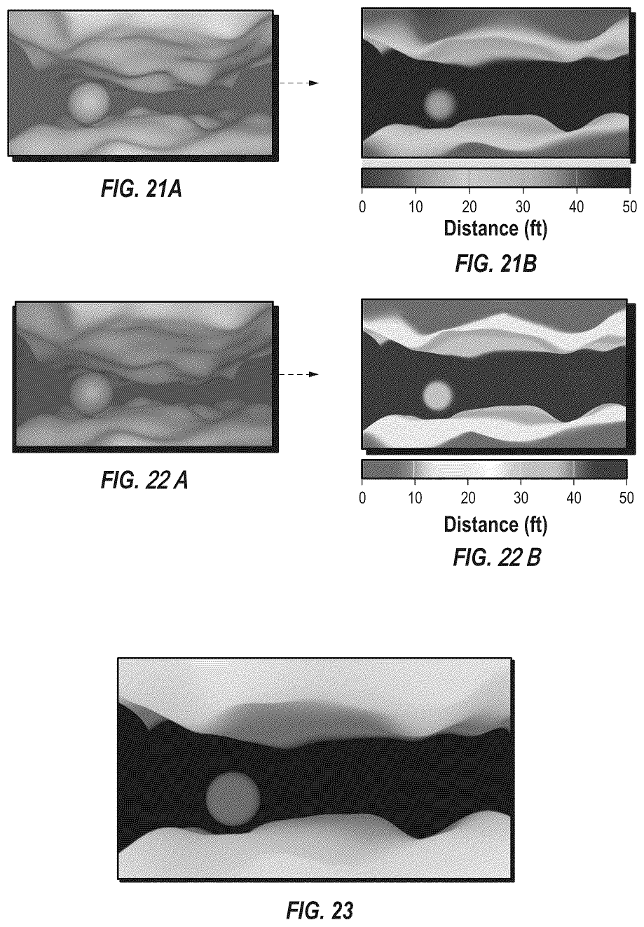

FIG. 20 illustrates a 3D visualization of the detected formation electrical properties boundaries based on variations in formation electrical properties, using the 1D graph from FIG. 21. FIG. 20 may provide insight for users to identify upcoming boundaries where formation electrical properties differ from a reference value. For example, high formation electrical properties may be identified and shown as a color, where low formation electrical properties may not be shown, or vice versa. In examples, a reference formation electrical property may either be the formation electrical property at the observation point 1100 of well measurement system 100 or a user-defined value, allowing the detected boundaries to highlight formation sections 2000 of particular interest to the users.

FIGS. 21A and 21B are illustrations showing a transformation of results from FIG. 20 into more practical geosteering information. As illustrated in FIGS. 21A and 21B, colors may be used to represent the actual distance to the boundaries of interest. Additionally, FIGS. 22A and 22B illustrate further indicate a distance to the boundary but also distinguishes the formation electrical property values by using positive or negative signs to define whether the boundary has higher or lower values, respectively. Further FIG. 23 illustrates a different color palette that may be used to convey the same information illustrated in FIG. 20.

This method and system may comprise any of the various features of the compositions, methods, and system disclosed herein, including one or more of the following statements.

Statement 1: A non-transitory machine-readable medium having data stored therein representing a software executable by a computer. The software executable comprising instructions may be configured to receive one or more electromagnetic measurements surrounding an observation point from a well measurement system, invert the one or more electromagnetic measurements to form one or more formation electrical properties, and visualize the one or more formation electrical properties on an information handling system. The instructions may be configured to further identify an azimuthal direction of a drill bit to follow in a formation based at least in part on the one or more formation electrical properties and instruct the drill bit to steer in the azimuthal direction.

Statement 2: The non-transitory machine-readable medium of statement 1, wherein the one or more formation electrical properties are visualized on the information handling system at different azimuthal directions from the observation point.

Statement 3: The non-transitory machine-readable medium of any previous statements 1 or 2, wherein the one or more formation electrical properties are visualized on the information handling system at an equal distance from the observation point.

Statement 4: The non-transitory machine-readable medium of any previous statements 1-3, wherein the formation electrical properties are one or more resistivity measurements, one or more resistivity boundaries, or one or more resistivity anisotropy.

Statement 5: The non-transitory machine-readable medium of statement 4, wherein the one or more resistivity measurements, the one or more resistivity boundaries, or the one or more resistivity anisotropy form at least in part one or more boundaries visualized on an information handling system.

Statement 6: The non-transitory machine-readable medium of any previous statements 1-4, further comprising form an uncertainty graph from one or more uncertainties created by the inverting the one or more electromagnetic measurements.

Statement 7: The non-transitory machine-readable medium of statement 6, wherein the uncertainty graph identifies distance to one or more boundaries in the formation.

Statement 8: The non-transitory machine-readable medium of statement 7, wherein the one or more boundaries are identified at least in part by one or more variations of resistivity measurements.

Statement 9: The non-transitory machine-readable medium of any previous statements 1-4 or 6, further comprising form a two dimensional (2D) curved image from the one or more formation electrical properties.

Statement 10: The non-transitory machine-readable medium of statement 9, wherein the 2D curved image identifies one or more uncertainties, wherein the one or more uncertainties are distances to one or more boundaries in the formation.

Statement 11: A method may comprise receiving one or more electromagnetic measurements surrounding an observation point from a well measurement system, inverting the one or more electromagnetic measurements to form one or more formation electrical properties, and visualizing the one or more formation electrical properties on an information handling system. The method may further comprise identifying an azimuthal direction for a drill bit to follow in a formation based at least in part on the one or more formation electrical properties and instructing the drill bit to steer in the azimuthal direction.

Statement 12: The method of statement 11, wherein the one or more formation electrical properties are visualized on the information handling system at different azimuthal directions from the observation point.

Statement 13: The method of any previous statements 11 or 12, wherein the one or more formation electrical properties are visualized on the information handling system at an equal distance from the observation point.

Statement 14: The method of any previous statements 11-13, wherein the formation electrical properties are one or more resistivity measurements, one or more resistivity boundaries, or one or more resistivity anisotropy.

Statement 15: The method of statement 15, wherein the one or more resistivity measurements, the one or more resistivity boundaries, or the one or more resistivity anisotropy form at least in part one or more boundaries visualized on an information handling system.

Statement 16: The method of any previous statements 11-14, further comprising forming an uncertainty graph from one or more uncertainties created by the inverting the one or more electromagnetic measurements.

Statement 17: The method of statement 16, wherein the uncertainty graph identifies distance to one or more boundaries in the formation.

Statement 18: The method of statement 17, wherein the one or more boundaries are identified at least in part by one or more variations of resistivity measurements.

Statement 19: The method of any previous statements 11-14 or 16, further comprising forming a two dimensional (2D) curved image from the one or more formation electrical properties.

Statement 20: The method of statement 19, wherein the 2D curved image identifies one or more uncertainties, wherein the one or more uncertainties are distances to one or more boundaries in the formation.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any comprised range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A non-transitory machine-readable medium having data stored therein representing a software executable by a computer, the software executable comprising instructions configured to:
receive one or more electromagnetic measurements surrounding an observation point from a well measurement system;
invert the one or more electromagnetic measurements to form one or more formation electrical properties;
visualize the one or more formation electrical properties on an information handling system;
identify an azimuthal direction of a drill bit to follow in a formation based at least in part on the one or more formation electrical properties; and
instruct the drill bit to steer in the azimuthal direction.

2. The non-transitory machine-readable medium of claim 1, wherein the one or more formation electrical properties are visualized on the information handling system at different azimuthal directions from the observation point.

3. The non-transitory machine-readable medium of claim 1, wherein the one or more formation electrical properties are visualized on the information handling system at an equal distance from the observation point.

4. The non-transitory machine-readable medium of claim 1, wherein the formation electrical properties are one or more resistivity measurements, one or more resistivity boundaries, or one or more resistivity anisotropy.

5. The non-transitory machine-readable medium of claim 4, wherein the one or more resistivity measurements, the one or more resistivity boundaries, or the one or more resistivity anisotropy form at least in part one or more boundaries visualized on an information handling system.

6. The non-transitory machine-readable medium of claim 1, further comprising form an uncertainty graph from one or more uncertainties created by the inverting the one or more electromagnetic measurements.

7. The non-transitory machine-readable medium of claim 6, wherein the uncertainty graph identifies distance to one or more boundaries in the formation.

8. The non-transitory machine-readable medium of claim 7, wherein the one or more boundaries are identified at least in part by one or more variations of resistivity measurements.

9. The non-transitory machine-readable medium of claim 1, further comprising form a two dimensional (2D) curved image from the one or more formation electrical properties.

10. The non-transitory machine-readable medium of claim 9, wherein the 2D curved image identifies one or more uncertainties, wherein the one or more uncertainties are distances to one or more boundaries in the formation.

11. A method comprising:
receiving one or more electromagnetic measurements surrounding an observation point from a well measurement system;
inverting the one or more electromagnetic measurements to form one or more formation electrical properties;
visualizing the one or more formation electrical properties on an information handling system;
identifying an azimuthal direction for a drill bit to follow in a formation based at least in part on the one or more formation electrical properties; and
instructing the drill bit to steer in the azimuthal direction.

12. The method of claim 11, wherein the one or more formation electrical properties are visualized on the information handling system at different azimuthal directions from the observation point.

13. The method of claim 11, wherein the one or more formation electrical properties are visualized on the information handling system at an equal distance from the observation point.

14. The method of claim 11, wherein the formation electrical properties are one or more resistivity measurements, one or more resistivity boundaries, or one or more resistivity anisotropy.

15. The method of claim 14, wherein the one or more resistivity measurements, the one or more resistivity boundaries, or the one or more resistivity anisotropy form at least in part one or more boundaries visualized on an information handling system.

16. The method of claim 11, further comprising forming an uncertainty graph from one or more uncertainties created by the inverting the one or more electromagnetic measurements.

17. The method of claim 16, wherein the uncertainty graph identifies distance to one or more boundaries in the formation.

18. The method of claim 17, wherein the one or more boundaries are identified at least in part by one or more variations of resistivity measurements.

19. The method of claim 11, further comprising forming a two dimensional (2D) curved image from the one or more formation electrical properties.

20. The method of claim 19, wherein the 2D curved image identifies one or more uncertainties, wherein the one or more uncertainties are distances to one or more boundaries in the formation.
